(19) United States
(12) Patent Application Publication
(10) Pub. No.: US 2014/0242459 A1
(43) Pub. Date: Aug. 28, 2014

(54) ELECTRODE FOR BATTERY, BATTERY, AND METHOD OF AND APPARATUS FOR MANUFACTURING ELECTRODE FOR BATTERY

(71) Applicant: DAINIPPON SCREEN MFG. CO., LTD., Kyoto (JP)

(72) Inventor: Masakazu SANADA, Kyoto (JP)

(73) Assignee: DAINIPPON SCREEN MFG. CO., LTD., Kyoto (JP)

(21) Appl. No.: 14/068,098

(22) Filed: Oct. 31, 2013

(30) Foreign Application Priority Data
Feb. 25, 2013 (JP) 2013-034168

(51) Int. Cl. H01M 4/13; H01M 4/139; H01M 4/04

(52) U.S. Cl. CPC H01M 4/13; H01M 4/0435; H01M 4/0404; H01M 4/139
USPC 429/211; 427/58; 118/313

(57) ABSTRACT

An electrode 10 for battery comprises: a base member 11 which serves as a current collector; and an active material layer 12 of an active material which is formed by a plurality of active material lines extending on a surface of the base member 11 along a predetermined longitudinal direction, wherein the active material lines include first lines 121 whose width in orthogonal cross section to the longitudinal direction is a first width W1 and second lines 122 whose width is a second width W2 which is wider than the first width W1 and whose height H2 measured from the surface of the base member is equal to or higher than a height H1 of the first lines.

### CROSS REFERENCE TO RELATED APPLICATION

The disclosure of Japanese Patent Application No. 2013-034168 filed on Feb. 25, 2013 including specification, drawings and claims is incorporated herein by reference in its entirety.

### BACKGROUND OF THE INVENTION

1. Field of the Invention

The present invention relates to a structure of an electrode for battery which is suitable to an electrochemical battery such as a lithium-ion secondary battery, and to a technique for manufacturing such an electrode.

2. Description of the Related Art

An electrochemical battery such as a lithium-ion secondary battery has a structure that a positive electrode and a negative electrode, each comprising a current collector layer and an active material layer, are opposed to each other across an electrolyte layer. Among methods of manufacturing these electrodes is a manufacturing method according to which an application liquid containing an active material is applied to a surface of a conductor, such as a metal foil, which serves as a current collector. Manufacturing methods of this type have customarily required “all-surface coating,” namely, coating of the entire surface of the current collector uniformly with the application liquid. To increase the surface area size of the active material layer and accordingly improve a charge/discharge characteristic, Patent Document 1 (JP2011-258367A) discloses a method of forming an active material layer of a stereostructure that the surface has concave and convex sections.

The technique according to Patent Document 1 uses the nozzle scan method as an applying method. To be precise, while a nozzle comprising a number of outlets moves relative to a base member which functions as a current collector, an application liquid containing an active material is continuously ejected from the outlets, whereby the application liquid is applied as lines to the surface of the base member. As a result of this, the active material pattern of the so-called line-and-space structure is formed in which a number of active material lines are arranged along the surface of the base member. The active material layer of this structure, as compared to an active material layer created by all-surface coating for instance, has a larger surface area size (more strictly speaking, the area size of the surfaces which contact the electrolyte layer) even when the amount of the active material used is the same, and therefore, makes it possible to form an electrode which exhibits a better charge/discharge characteristic.

When exercised to manufacture electrodes of the above structure and batteries using such electrodes on an industrial scale, the conventional technique according to Patent Document 1 still leaves a room for further improvement. That is, the manufacturing steps until completion of a battery which uses the electrode having the above structure can include a certain number of steps at which pressing force in the orthogonal direction to the principal surface of the electrode is applied to the electrode. For example, a mass production method of electrodes may be the so-called “roll-to-roll method” according to which applying is performed while pulling out at a constant speed a base member of a long sheet which is wound like a roll and the coated base member is wound up again into a roll. While this method is practiced, pressing force is applied upon the active material layer which is sandwiched between the folds of the base member. Further, for example, the active material layer created by applying may be treated with pressing for the purpose of increasing the density of the active material layer. Moreover, the positive electrode and the negative electrode may be pressed to each other during the stage of inserting the electrolyte layer between the positive electrode and the negative electrode in order to complete the battery.

For enhancement of the charge/discharge characteristic of the battery, it is desirable that the aspect ratio of the active material pattern (i.e., the ratio of the pattern height to the pattern width) is high. While the conventional technique above makes it possible to form high aspect-ratio patterns, there may be a problem that high aspect-ratio patterns tend to get buckled and collapse when pressed along the direction of height.

### SUMMARY OF THE INVENTION

The invention was made in light of the problem described above, and therefore, an object of the invention is to provide an electrode for battery which effectively prevents pressing-induced buckling and collapse while securing a favorable charge/discharge characteristic and to provide a technique for manufacturing such an electrode.

To achieve the object above, the electrode for battery according to one aspect of the invention comprises: a base member which serves as a current collector; and an active material layer of an active material which is formed by a plurality of active material lines extending on a surface of the base member along a predetermined longitudinal direction, wherein the active material lines include first lines whose width in orthogonal cross section to the longitudinal direction is a first width and second lines whose width in orthogonal cross section to the longitudinal direction is a second width which is wider than the first width and whose height measured from the surface of the base member is equal to or higher than the height of the first lines.

In this structure according to the invention, the first lines having the narrow width and the second lines having the wider width are mingled with each other in the active material layer formed on the surface of the base member. The height of the second lines measured from the surface of the base member is equal to or higher than the height of the first lines.

The surface area size of the first lines having the relatively narrow width is relatively large considering the amount of the active material of which the lines are made, and therefore, the first lines contribute to improvement of the charge/discharge characteristic of the battery. When pressing force acts from the orthogonal direction to the surface of the base member, namely, the direction of the height of the active material lines, the load is dispersed at the second lines which have the relatively wide width so that it is possible to prevent buckling and collapse and enhance the durability.

Thus, since the electrode for battery according to the invention comprises the active material layer in which the first lines which are in charge of a high-speed charge/discharge and the second lines which are in charge of resistance against pressing force are mingled with each other, it is possible to effectively prevent pressing-induced buckling and collapse while attaining a favorable charge/discharge characteristic. The line widths and the arrangements of the first and the second lines may be set to various values and various arrangements in accordance with an electric characteristic, mechanical strength and the like which are required.

To achieve the object above, the battery according to one aspect of the invention comprises: a positive electrode including a positive electrode current collector and a positive active material layer; a negative electrode including a negative electrode current collector and a negative active material layer; and an electrolyte layer which is disposed between the positive electrode and the negative electrode, wherein at least one of the positive electrode and the negative electrode has the same structure as that of the electrode for battery described above. When the electrode for battery according to the invention is used, it is possible to manufacture a battery which exhibits the high-speed charge/discharge characteristic of the electrode for battery above and it is possible to prevent pressing from harming this characteristic during manufacture of the battery. In short, the battery according to the invention exhibits an excellent charge/discharge characteristic. Further, since the durability of the electrode for battery against pressing force remains available even after the electrode is integrated into a battery, the battery is highly durable against external force.

To achieve the object above, the method of manufacturing the electrode for battery according to one aspect of the invention comprises the steps of: applying an application liquid containing an active material to the surface of the base member, which serves as a current collector, in the form of lines and accordingly forming first lines made of the active material which extend in a predetermined longitudinal direction and whose width in orthogonal cross section to the longitudinal direction is a first width; and applying the application liquid to the surface of the base member at different positions from the positions of the first lines in the form of lines and accordingly forming second lines made of the active material which extend in the predetermined longitudinal direction and whose width in orthogonal cross section to the longitudinal direction is a second width which is wider than the first width and whose height measured from the surface of the base member is equal to or higher than the height of the first lines. As described above, this structure according to the invention makes it possible to manufacture an electrode for battery which has an excellent charge/discharge characteristic and high durability against pressing force.

To achieve the object above, the apparatus for manufacturing the electrode for battery according to one aspect of the invention comprises: an application liquid ejector which includes a plurality of outlets which are arranged in a line in a predetermined arrangement direction and ejecting the application liquid containing an active material from each one of the outlets; and a relative mover which moves the base member and the application liquid ejector relative to each other in a direction which intersects the arrangement direction in a condition that the surface of the base member which functions as a current collector is opposed to each one of the plurality of outlets, wherein the plurality of outlets include a plurality of first outlets which have the same aperture width in the arrangement direction and a plurality of second outlets which have the same aperture width in the arrangement direction and whose aperture width is wider than that of first outlets, the active material contained in the application liquid ejected from the first outlets forms, on the surface of the base member, first lines which have a first width, and the active material contained in the application liquid ejected from the second outlets forms, on the surface of the base member, second lines which have a second width which is wider than the first width and whose height measured from the surface of the base member is equal to or higher than the height of the first lines. As described above, this structure according to the invention makes it possible to manufacture an electrode for battery which has an excellent charge/discharge characteristic and high durability against pressing force.

According to the invention, the electrode for battery comprises the active material layer in which the first lines in charge of a high-speed charge/discharge and the second lines in charge of resistance against pressing force are mingled with each other, and therefore, it is possible to effectively prevent pressing-induced buckling and collapse while attaining a favorable charge/discharge characteristic.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIGS. 1A and 1B are drawings which show an example of the structure of the battery which is manufactured according to the invention.

FIG. 2 is a schematic diagram which shows the principal structure of the electrode manufacturing apparatus for manufacturing the negative electrode.

FIGS. 3A and 3B are drawings which show the structure of the application nozzle in detail.

FIG. 4 is a flow chart which shows steps of manufacturing a battery using the electrode for battery according to this invention.

FIGS. 5A through 5C are drawings which show the relationship between the cross sectional shape of the active material lines and the durability against pressing force.

FIGS. 6A through 6D are drawings which show other preferable examples of the cross sectional shape of the active material layer.

### DETAILED DESCRIPTION OF THE PREFERRED EMBODIMENTS

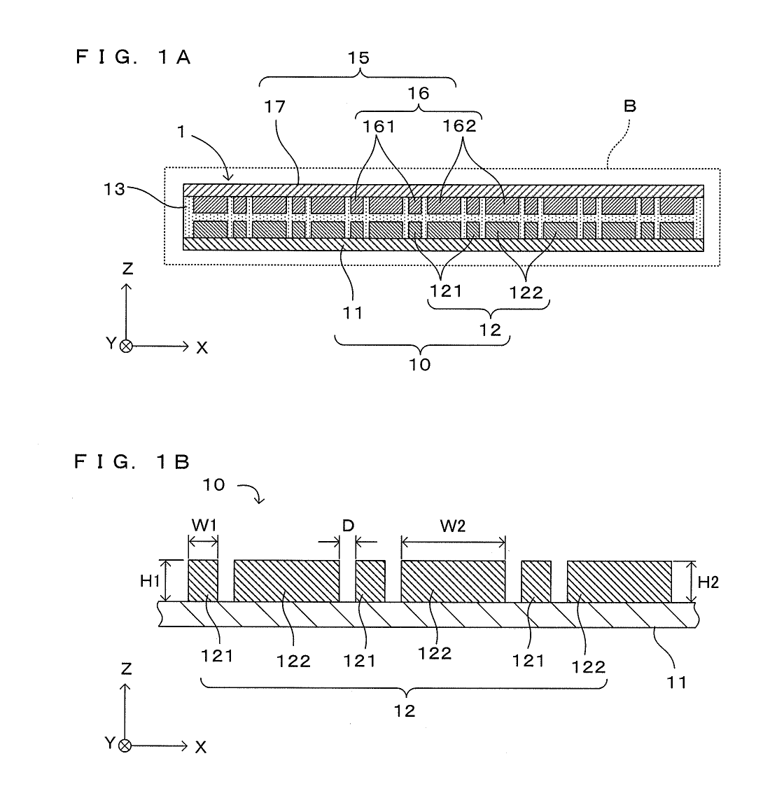

FIGS. 1A and 1B are drawings which show an example of the structure of the battery which is manufactured according to the invention. To be specific, FIG. 1A is a schematic diagram of the cross sectional structure of a battery module in which the electrode for battery according to an embodiment of the invention is used as a positive electrode and a negative electrode, and FIG. 1B is a view of the negative electrode. While a lithium-ion secondary battery module will be described below as an example of the battery module 1, with a proper change of ingredients, a similar concept is applicable to various types of electrochemical batteries as well in addition to lithium-ion secondary batteries.

The battery module 1 has a multi-layer structure that a negative active material layer 12, an electrolyte layer 13 and a positive electrode 15, which includes a positive active material layer 16 and a positive electrode current collector 17, are stacked one atop the other on a negative electrode current collector 11. The X-coordinate direction, the Y-coordinate direction and the Z-coordinate direction are herein defined as shown in FIG. 1A.

FIG. 1B shows the structure of a negative electrode 10 which is obtained as the negative active material layer 12 is formed on a surface of the negative electrode current collector 11. As shown in FIG. 1B, the negative active material layer 12 has a line-and-space structure that a number of active material lines 121 and 122 extending like lines in the Y-direction are arranged at constant intervals in the X-direction. To be more precise, the negative active material layer 12 has a structure that the first lines 121 and the second lines 122 are arranged alternately in the X-direction. The first lines 121 has height H1 as measured from the surface of the current collector 11 and width W1 as measured along a width direction (the X-direction) which is orthogonal to a pattern longitudinal direction (the Y-direction) at bottom portions which are in contact with the surface of the current collector 11. The second lines 122 has height H2 as measured from the surface of the current collector 11 and width W2 as measured at bottom portions which are in contact with the surface of the current collector 11.

The active material lines 121 and 122 all have the same composition which contains a negative active material. While the height H1 of the first lines 121 and the height H2 of the second lines 122 are the same, the width W2 of the second lines 122 is wider than the width W1 of the first lines 121. A gap D of a line pair consisting of the mutually adjacent paired active material lines 121 and 122 remains approximately the same among the line pairs.

Typically, the width W1 of the first lines 121 is approximately from 50 μm to 70 μm, the width W2 of the second lines 122 is approximately from 1 mm to 3 mm, the height H1 of the first lines 121 and the height H2 of the second lines 122 are approximately from 70 μm to 200 μm, and the line gap D is approximately from 30 μm to 70 μm. The ratio of the height H1 of the first lines 121 to the width W1 of the first lines 121, namely, the aspect ratio (H1/W1) is preferably 1 or higher. That is, it is desirable that the height H1 is equal to the width W1 or greater. Meanwhile, the aspect ratio of the second lines 122 (H2/W2) is preferably lower than 1: it is desirable that the width W2 is greater than the height H2. As described in detail later, these are preferred conditions for achieving both a high-speed charge/discharge characteristic and durability against pressing force which is applied upon the electrodes.

The positive electrode 15 has a similar structure to the negative electrode 10. More particularly, the positive electrode 15 has a structure that the positive active material layer 16, which is formed by two types of active material lines 161 and 162 having the same height measured from the surface of the current collector but different widths from each other, is formed on the surface of the positive electrode current collector 17. The conditions regarding the dimensions of the first lines 121 of the negative active material layer 12 described above are applied to the active material lines 161, while the conditions regarding the dimensions of the second lines 122 of the negative active material layer 12 are applied to the active material lines 162. However, the positive active material layer 16 does not necessarily have to have the same dimensions as the negative active material layer 12.

The positive electrode 15 and the negative electrode 10 which have the above structures are positioned opposed to each other such that their active material layers are directed inwardly, and the electrolyte layer 13 is formed between the two. The electrolyte layer 13 may be made of a solid electrolytic material filled into the space between the positive electrode 15 and the negative electrode 10, or may be formed by a separator and an electrolytic liquid. As a tab electrode is appropriately disposed to the lithium-ion secondary battery module 1 thus formed or a plurality of such modules are stacked one atop the other, whereby a lithium-ion secondary battery B is obtained.

With respect to materials for forming the respective layers of the lithium-ion secondary battery module 1, an aluminum foil and a copper foil may for instance be used respectively as the positive current collector 17 and the negative current collector 11. For the positive active material layer 16, a known positive active material such as a material mainly containing LiCoO₂ (LCO), LiNiO₂, LiFePO₄, LiMnPO₄, LiMn₂O₄ or compounds represented by LiMeO₂ (Me=MₓM_{y}M_{z}; Me, M are transition metal elements and x+y+z=1) such as LiNi_{1/3}Mn_{1/3}Co_{1/3}O₂ and LiNi_{0.8}Co_{0.15}Al_{0.05}O₂ can be used as the positive active material.

A material mainly containing Li₄Ti₅O₁₂ (LTO), C, Si (or compounds containing at least one of these elements) or Sn can be, for example, used as the negative active material. Furthermore, a polypropylene (PP) sheet may for example be used as a separator of the electrolyte layer 13, and a mixture of ethylene carbonate and diethyl carbonate (EC/DEC) containing lithium salt as supporting electrolyte, lithium hexafluorophosphates (LiPF₆) e.g., can be used as an electrolyte fluid of the electrolyte layer 13. A solid electrolyte material containing a mixture of polyethylene oxide and polystyrene may be, for example, used as the electrolyte material layer 13. Note that the materials for the respective functional layers are not limited to these.

Next, the manufacturing method of the negative electrode 10 having the above structure will be described. While the foregoing takes up the negative electrode 10 as an example, the manufacturing method of the positive electrode 15 is basically the same, however with a change of the ingredients. A base member, which serves as a negative electrode current collector, is a copper foil or resin sheet laminated with a thin layer of copper, and an application liquid containing the negative electrode active material is applied to the base member in the form of lines, thereby fabricating the negative electrode 10. The apparatus for and the method of manufacturing the electrode will now be described.

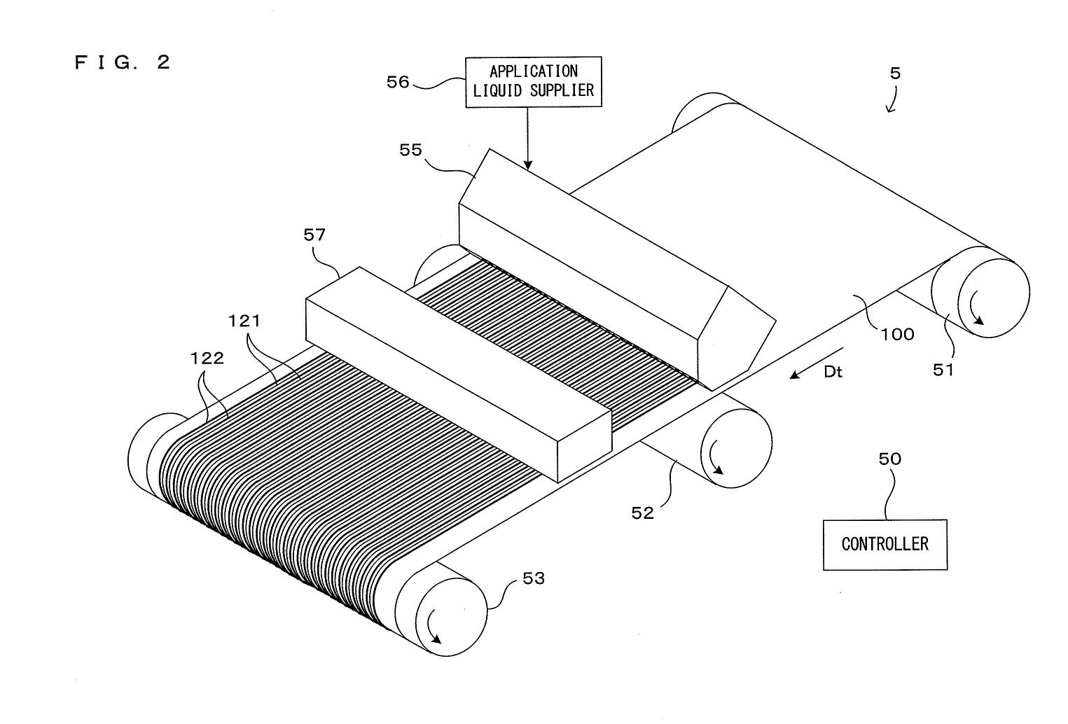

FIG. 2 is a schematic diagram which shows the principal structure of the electrode manufacturing apparatus for manufacturing the negative electrode. The electrode manufacturing apparatus 5 comprises a supply roller 51 for feeding a base member 100 which is a long sheet wound as a roll, a winding roller 53 for winding up the base member 100 while maintaining the base member 100 tense to a constant degree as the base member 100 is fed, and a back-up roller 52 which abuts on one surface of the base member 100 on a transportation path for the base member 100 which is from the supply roller 51 to the winding roller 53. These rollers have rotation shafts which are parallel to each other and a controller 50 controls rotations of these rollers. As the rollers rotate, the base member 100 is transported at a constant speed in a predetermined transportation direction Dt.

An application nozzle 55 is disposed opposed to the back-up roller 52 so as to be positioned in the vicinity of the opposite surface of the base member 100 to the back-up roller 52. The application nozzle 55 is fed with the application liquid from an application liquid supplier 56, ejects the application liquid in response to a control command received from the controller 50 and accordingly applies the application liquid to the surface of the base member 100 which moves passed the opposed position to the application nozzle 55. As described in detail later, a number of outlets are formed in the application nozzle 55 and the application liquid is ejected continuously from these outlets. Owing to the application liquid, a number of line-shaped patterns which are parallel to each other are consequently created on the surface of the base member 100 in the transportation direction Dt.

A drier unit 57 for drying the application liquid applied to the base member 100 is disposed on the downstream side to the application nozzle 55 in the transportation direction Dt for the base member 100. The drier unit 57 blows dry air toward the surface of the base member 100 or applies heat to the surface of the base member 100 by blowing of warm air or by irradiation of an electromagnetic wave including infrared light, thereby volatilizing a solvent ingredient contained in the application liquid. The application liquid then hardens so that the lines 121 and 122 of the active material are formed.

The base member 100 now bearing the active material lines 121 and 122 is wound up again into a roll by the winding roller 53. At this stage, the base member 100 wound in such a manner that the active material lines 121 and 122 formed on the surface of the base member 100 are directed toward outside.

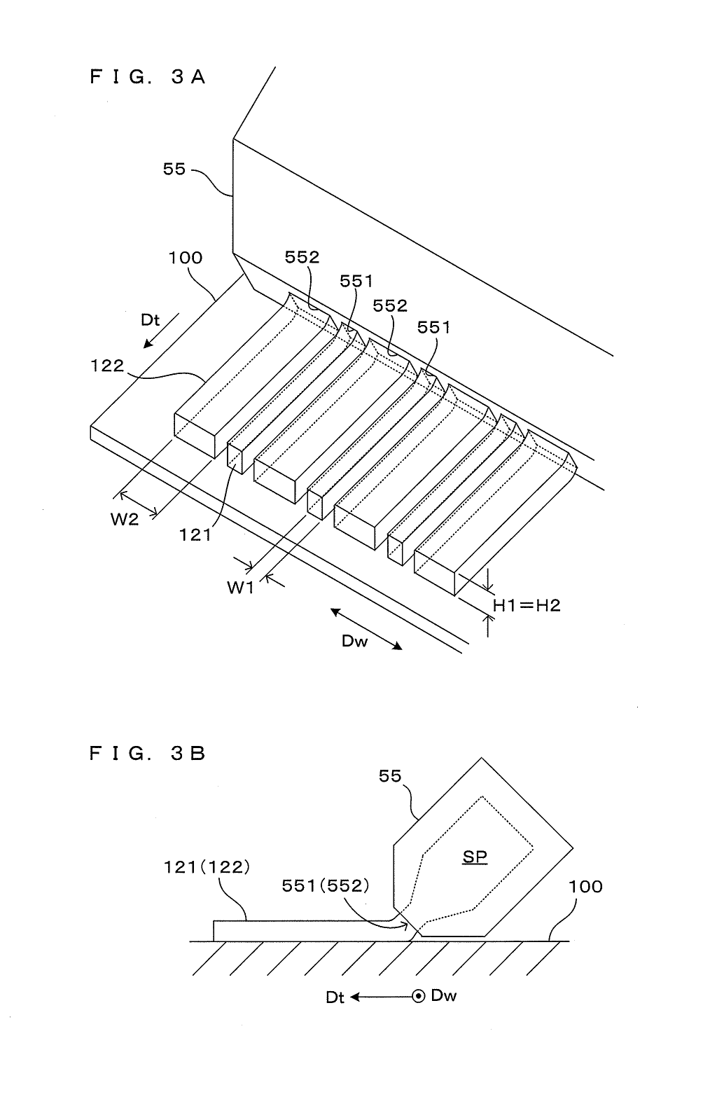

FIGS. 3A and 3B are drawings which show the structure of the application nozzle in detail. More particularly, FIG. 3A is a partially expanded perspective view of the application nozzle 55, and FIG. 3B is a side view which shows the internal structure of the application nozzle 55. In a lower section of the application nozzle 55, a number of outlets are provided in a row along a width direction Dw which is orthogonal to the transportation direction Dt for the base member 100. To be more precise, first outlets 551 whose aperture size is relatively small in the width direction Dw and second outlets 552 whose aperture size is larger in the width direction Dw are arranged alternately in the width direction Dw. The aperture size of the outlets in the direction of height which is orthogonal to the surface of the base member 100 is the same.

The outlets 551 and 552 are contiguous to a single reservoir space SP which is created inside the application nozzle 55 so that the application liquid is supplied to the reservoir space SP from the application liquid supplier 56. Describing more particularly, as feeding of the application liquid under pressure from the application liquid supplier 56 starts in response to a control command from the controller 50, the application liquid earlier fed into the reservoir space SP is ejected from the outlets 551 and 552 and reaches the surface of the base member 100. As the base member 100 moves in the transportation direction Dt while the application liquid is continuously ejected from the outlets 551 and 552, the position of contact of the application liquid with the base member 100 gradually changes on the base member 100, thereby a number of continuous active material lines which are along the transportation direction Dt on the surface of the base member 100. The relatively narrow first lines 121 are formed from the application liquid ejected from the first outlets 551 which have the small aperture size. In the meantime, the relatively wide second lines 122 are formed from the application liquid ejected from the second outlets 552 which have the larger aperture size. The outlets are open at the same height, and therefore, the lines are at the same height.

As the application liquid containing the active material, a mixture of the active material, acetylene black or ketjen black as a conduction aid, polyvinylidene fluoride (PVDF), styrene butadiene rubber (SBR), polyvinyl pyrrolidone (PVP), polyvinyl alcohol (PVA) or polytetrafluoroethylene (PTFE) as a binder, N-methyl-2-pyrrolidone (NMP) as a solvent and the like can be used.

The mixing ratio of these ingredients is so adjusted to make the viscosity of the application liquid relatively high, which makes it possible to form patterns which maintain their very initial cross sectional shapes as they are immediately after ejection. When the application liquid is dried quickly after applied, the effect of this is even greater. As shown in FIG. 3A, when the outlets 551 and 552 have a rectangular aperture shape, it is possible to form the active material lines 121 and 122 whose cross sectional shape is approximately rectangular. While the cross sectional shape of the lines generally follows the aperture shape of the outlets, the application liquid may sometimes spread after ejected or shrink during drying, in which case the cross sectional shape, the dimensions or the like of the lines become slightly different from the aperture shape of the outlets.

Applying like this is attained by the nozzle scan method which requires continuous ejection of an application liquid from a nozzle while moving the nozzle relative to an object to be applied. As the nozzle scan method allows to apply high pressure upon a highly viscous application liquid and continuously push out the application liquid, utilizing the aperture shape of the outlets, the cross sectional shape of the lines can be controlled. In addition, as the numerous outlets are provided, it is possible to form a number of lines at the same time. This applying method is thus particularly preferable when a number of lines having a high aspect ratio need be formed.

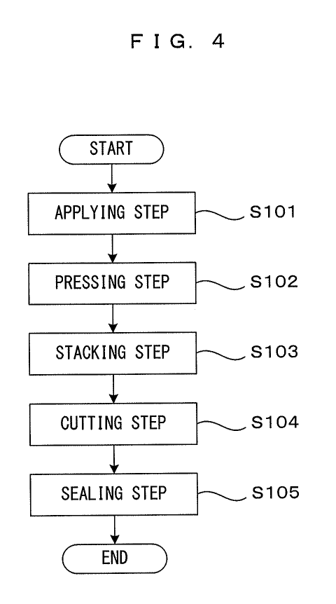

FIG. 4 is a flow chart which shows steps of manufacturing a battery using the electrode for battery according to this invention. Among these steps, first, the positive and the negative electrodes are fabricated. That is, using the electrode manufacturing apparatus 5 described above, the application liquid containing the active material is applied to the surface of the base member 100 which serves as a current collector (the applying step; Step S101). Following this, the active material layer formed on the surface of the base member is pressurized with predetermined pressing force, the density of the active material layer is increased (the pressing step; Step S102). The pressing step may be omitted in some cases. In this manner, the positive electrode is formed from the positive electrode current collector and the positive active material and the negative electrode is formed from the negative electrode current collector and the negative active material.

The positive electrode and the negative electrode thus formed are stacked one atop the other together with the electrolyte layer which is sandwiched between the electrodes (the stacking step; Step S103). A laminate thus formed is cut into a necessary size (the cutting step; Step S104), thereby completing the lithium-ion secondary battery module 1. This module is bent or wound as needed and sealed in a predetermined package (the sealing step; Step S105), the lithium-ion secondary battery B is completed.

At these steps, there are stages at which the active material layer which has been formed by applying of the surface of the base member is pressed from the direction of height. For instance, when the long sheet-like base member seating the lines of the active material is wound up into a roll, pressing force acts upon the active material lines which are between the overlapping folds of the base member. At the later pressing step as well, the active material lines are of course pressed. Further, at the stacking step and the sealing step as well, similar pressing force may be applied upon the active material lines.

As compared to lines which have a low aspect ratio, the active material lines having the increased aspect ratio for the purpose of improving the charge/discharge characteristic owing to the enlarged surface area size which contact the electrolyte layer tend to have inferior durability against pressing force along the height direction.

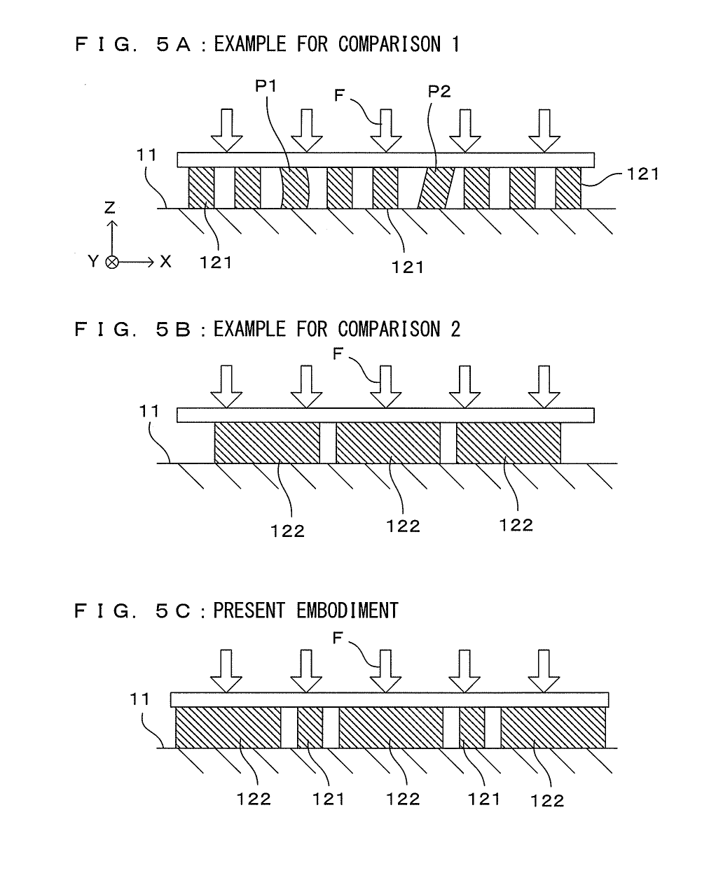

FIGS. 5A through 5C are drawings which show the relationship between the cross sectional shape of the active material lines and the durability against pressing force. As shown as Example for Comparison 1 in FIG. 5A, in the case of a pattern arrangement which is formed only by a number of the first lines 121 which have the high aspect ratio, since the buckling load of the respective lines against pressing force F from the direction of height (the Z-direction) is relatively small, a line pattern P1 which gets buckled to the pressing force F and a line pattern P2 which collapses to the pressing force F will easily appear.

Meanwhile, as shown as Example for Comparison 2 in FIG. 5B, in the case of a pattern arrangement which is formed only by a number of the second lines 122 which have the low aspect ratio, since the buckling load of the respective lines is large, buckling or collapse of the lines because of the pressing force F will not easily occur. On the other hand, the surface area size cannot be increased relative to the amount of the active material which is used, and therefore, this pattern arrangement is inferior in terms of high-speed charge/discharge characteristic. As an extreme example, when the active material layer is formed by continuous and entire coating, i.e., all-surface coating, while durability against pressing force increases, an excellent charge/discharge characteristic cannot be obtained which is otherwise realized when the active material has a stereostructure.

When the electrode according to this embodiment has the structure shown in FIG. 5C, the wide second lines 122 whose apexes have large areas resist against the pressing force F, whereas the narrow first lines 121 having the high aspect ratio are dispersed among the second lines maintain an excellent charge/discharge characteristic which is owing to the large surface area size without causing buckling to the pressing force F. The electrode structure according to this embodiment comprises the active material layer in which the wide second lines 122 which are durable against the pressing force F and the high aspect-ratio first lines 121 exhibiting an high-speed excellent charge/discharge characteristic are mingled with each other, which attains both durability against the pressing force F and an excellent charge/discharge characteristic.

According to the findings obtained by the inventors of the invention through studying of line patterns having various aspect ratios, the problem of buckling due to pressing force does not occur almost at all among lines whose cross sections have an aspect ratio of lower than 1. However, such a line pattern is disadvantageous with respect to a high-speed charge/discharge characteristic. For attaining a favorable charge/discharge characteristic, it is desirable that the aspect ratio of lines is equal to 1 or greater. However, lines having oblong cross sections have a low buckling load, and therefore, these lines have a problem that they are fragile against pressure from the direction of height. Considering these, a desirable structure is mixture of the first lines 121 whose aspect ratio is equal to 1 or greater and the second lines 122 whose aspect ratio is lower than 1 in which lines in charge of high-speed charge/discharge are the first lines 121 and lines in charge of durability against pressing are the second lines 122.

As described above, according to this embodiment, the width W1 of the first lines 121 is approximately from 50 μm to 70 μm, the width W2 of the second lines 122 is approximately 1 mm to 3 mm, the height H1 of the first lines 121 and the height H2 of the second lines 122 is approximately from 70 μm to 200 μm. To note particularly, the aspect ratio (H1/W1) of the first lines 121 is preferably 1 or higher.

As for the line gap D (FIG. 1B), since the spaces between the lines are dead spaces which are not filled with the active material, it is preferable that the gap takes a small value from the perspective of the battery capacity. However, according to the findings obtained by the inventors, even when the active material layer has the line-and-space structure, improvement of the charge/discharge characteristic which is unique to this structure will not be achieved when the line gap D is 30 μm or less. Considering these, the line gap D is approximately from 30 μm to 70 μm according to this embodiment. Since durability against pressing force decreases in an area with a wide line gap if any in the arrangement of the active material lines, it is desirable that the space between the adjacent lines remains constant at any position on the electrode regardless of the line width. The numerical values above are examples of the dimensions which make it possible to realize both a charge/discharge characteristic and strength against pressing force.

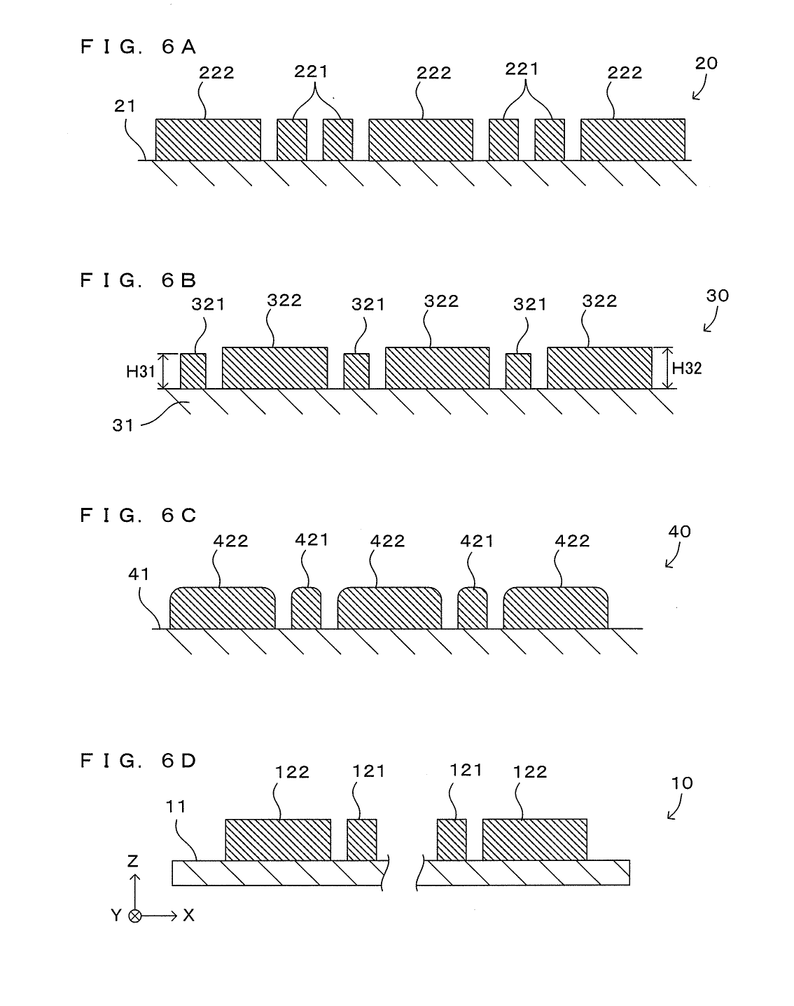

FIGS. 6A through 6D are drawings which show other preferable examples of the cross sectional shape of the active material layer. In the case of an electrode 20 according to the example in FIG. 6A, between second lines 222 which are wide and have a low aspect ratio, there are two first lines 221 each which are narrower and have a high aspect ratio on a base member 21. Two pieces or more of the first lines may be thus disposed each between the second lines as in this example: the alternating arrangement in which the first lines and the second lines are alternately laid one each is not limiting. Nevertheless, it is desirable that the first lines and the second lines are arranged regularly so as to prevent durability against pressing force from deteriorating in a particular place. A structure that many first lines are lined up successively next to each other is not desirable. This is because in a structure that a particular section is crowded with many first lines for example, durability against pressing force locally decreases in this section than in other areas and pressing force initiates buckling.

Insertion of at least one piece of the first lines between two pieces of the wide second lines is more preferable than arranging two pieces of the wide second lines. While durability against pressing force increases where the second lines are arranged next to each other, even though strength is greater in a particular section alone than in other sections, overall strength as the electrode or battery as a whole may not become necessarily greater. Rather, this is a disadvantage in terms of the effect of increasing the surface area size of the active material layer. It then follows that arranging at least one piece of the first lines between two pieces of the second lines is more effective for the purpose of realizing both durability against pressing force and a high-speed charge/discharge characteristic. In an effective pattern arrangement, the narrow first lines which have a high aspect ratio are primarily arranged for maintenance of a favorable charge/discharge characteristic and the second lines are dispersed among the first lines for enhanced strength.

In the case of an electrode 30 according to the example in FIG. 6B, height 1131 of narrow first lines 321 having a high aspect ratio which are provided on a base member 31 is set to be lower than height 1132 of wider second lines 322 having a low aspect ratio. In such a structure, most of pressing force from the direction of height acts upon the second lines 322 so that pressing force upon the first lines 321 can be suppressed extremely small. Hence, the cross sectional shape of the first lines 321 can be set for a charge/discharge characteristic, without considering the issue of strength. A plurality of the first lines 321 may of course be disposed between the second lines 322 in this example as well. When the first lines are taller than the second lines on the contrary, pressing force is concentrated upon the first lines which have a low buckling load, which leads to buckling or collapse of the lines.

While the cross sectional shapes of the first and the second lines are approximately rectangular in the electrodes described above, this is not limiting. In the case of an electrode 40 according to the example in FIG. 6C, surfaces of first lines 421 and second lines 422 are convex curved surfaces. Such a shape results from rounding of the surface of the application liquid due to surface tension when the viscosity of the application liquid is relatively low, long time is necessary for drying of the application liquid, etc. Even in these instances, mixed arrangement of the narrow first lines 421 and the wider second lines 422 makes it possible to obtain an electrode which exhibits an excellent charge/discharge characteristic which is owing to the increased surface area size of the active material layer and durability against pressing force which is owing to the dispersed arrangement of the lines which have a high buckling load. The line width in such instances may be defined by the widths of the lines 421 and 422 which are measured where these lines are in contact with a base member 41 for instance.

In each one of these examples above, as shown in FIG. 6D, it is preferable that the closest lines to the both edges of the electrode 10 in the orthogonal direction (the X-direction) to the line longitudinal direction (the Y-direction) are the second lines 122 which are wide and strong against pressing rather than the first lines 121 which are narrow. Local pressing force tends to act upon the edge portions of the electrode than upon the central portion, and pressing force from an oblique direction in particular which is different from the height direction may act upon the active material lines. To prevent buckling or collapse of the lines due to this, the wide second lines 122 which are stronger against pressing force are preferably disposed at outermost positions of the electrode 10. In this sense, two pieces or more of the second lines may be disposed at the edges of the electrode for further enhancement of strength.

As described above, in this embodiment, the negative electrode current collector 11 corresponds to the “base member” of the invention, the negative active material layer 12 corresponds to the “active material layer” of the invention, and the negative electrode 10 which is integration of these corresponds to the “electrode for battery” of the invention. In addition, the first lines 121 and the second lines 122 made of the negative active material correspond to the “active material lines” of the invention.

Further, in the electrode manufacturing apparatus 5 according to the embodiment above, the application nozzle 55 functions as the “application liquid ejector” of the invention, while the supply roller 51 and the winding roller 53 jointly function as the “relative mover” of the invention. The winding roller 53 functions also as the “winder” of the invention.

As illustrated with the above embodiments, in the electrode for battery according to the invention, at least one piece of the first lines may be disposed between two pieces of the second lines for instance. The second lines enhance durability of the electrode for battery against pressing force but are disadvantageous than the first lines in terms of charge/discharge characteristic. Hence, as compared to arranging of two pieces of the second lines, disposing at least one piece of the first lines between two pieces of the second lines is more advantageous in realizing both durability against pressing force and a high-speed charge/discharge characteristic.

Further, as for the second lines, it is desirable that the ratio of the height to the width in cross section, namely, the aspect ratio is smaller than 1 for instance. When the second lines are formed such that its width is greater than its height, buckling of the second lines will not occur almost at all despite pressing from the direction of height, thereby further improving the durability against pressing force.

Meanwhile, with respect to the first lines, it is desirable that their aspect ratio is 1 or greater. Because of the presence of the wide second lines between the first lines, buckling of the first lines is extremely unlikely, which allows to set the aspect ratio of the first lines without considering pressing. When the aspect ratio of the first lines is 1 or greater in particular, it is possible to effectively increase the surface area size of the active material layer which comes into contact the electrolyte layer when the battery is completed, and therefore, to further improve the charge/discharge characteristic.

Further alternatively, the line gap of a line pair consisting of two adjacent active material lines may remain the same in any line pairs. When pressing force is applied upon an electrode for battery in which the line gap is not constant, stress gets concentrated in a section where the line gap is large and buckling or collapse of active material lines will occur easily. When the line gap is constant, it is possible to disperse pressing force and even more effectively prevent buckling, collapse, etc.

Further, it is preferable for example that the active material lines are arranged such that the outermost active material lines among the active material lines arranged on the base member are the second lines. The outermost active material lines are prone to pressing force from outside and sometimes subject to external force from an oblique direction in particular which is different from the height direction in particular. When the second lines which are highly durable against pressing force are the outermost active material lines, it is possible to prevent buckling or collapse of the inner first lines without fail.

Further, the manufacturing method of the electrode for battery according to the invention may require for instance that the application liquid is applied to the surface of the base member while the base member and the application liquid ejector, in which the plurality of outlets for continuously ejecting the application liquid are provided, are moved relative to each other in the longitudinal direction, the plurality of outlets may include the first outlets whose aperture width corresponds to the first width and the second outlets whose aperture width corresponds to the second width, and the application liquid may be ejected simultaneously from the first outlets and the second outlets. This allows to efficiently manufacture in a short period of time the electrode for battery which has the characteristics and features described above.

In this case, the method may further comprise the step of applying the application liquid to the surface of the base member while the sheet-like base member is transported in the longitudinal direction and winding the base member now the application liquid is applied, for instance. As described earlier, although the active material layer formed by applying may be pressed when the base member is wound up, since it is possible to form the active material layer which is highly durable against pressing force according to the invention, buckling or collapse of the active material lines due to pressing can be effectively prevented.

Further, the method may further comprise the step of pressing the first lines and the second lines formed on the surface of the base member with predetermined pressing force for instance. Pressing of the first and the second lines makes it possible to increase the density of the active material layer and enhance the energy density as the electrode. Although pressing may cause buckling or collapse of the active material lines and consequently deteriorate the performance, the invention solves this problem.

Further, the apparatus for manufacturing the electrode for battery according to the invention may further comprise for instance a winder which winds up the sheet-like base member after application of the application liquid. Since it is possible to form the active material layer which is highly durable against pressing force according to the invention, it is possible to effectively prevent pressing-induced buckling or collapse of the active material lines during winding up.

The invention is not limited to the embodiment above but may be modified in various manners besides the embodiment above to the extent not deviating from the object of the invention. For instance, in the electrode 10, etc. according to the embodiments above, the presence of both of the two types of active material lines having different line widths from each other realizes both a high-speed charge/discharge characteristic and durability against pressing force. However, this is not limiting: the pattern may further include lines which have a third width which is different from the widths of the first and the second lines. Even in such an instance as well, the higher the aspect ratio of the lines is, the greater contribution the lines make primarily to a high-speed charge/discharge characteristic while the lower the aspect ratio of the lines is, the greater contribution the lines make primarily to durability against pressing force.

For instance, the electrode manufacturing apparatus 5 according to the embodiment above continuously manufactures electrodes by the manufacturing method of the roll-to-roll type which requires applying the application liquid containing the active material to the base member 100 which is a long sheet and wound up into the form of a roll and then winding up the base member 100 again. However, the invention is not limited to this: the invention is applicable also for example to a manufacturing apparatus and a manufacturing method of the single wafer processing type which requires applying an application liquid to base members which are independent of each other. This is because pressing force may act upon the electrodes when the electrodes are stacked, during sealing into a package, etc., in the case of a manufacturing method of the single wafer processing type as well.

The cross sectional shape of the active material lines according to the embodiment above is merely one example and is not limiting: any desired cross sectional shape may be used. The aperture shape of the outlets provided in the application nozzle is not limited to a rectangle, either, which is the shape used in the embodiment above: various aperture shapes may be used.

Further, the battery according to the embodiment above is a lithium-ion secondary battery, the foregoing has merely described an example of the ingredients of the functional layers and the ingredients above are not limiting. In addition, the structure and the manufacturing technique according to the invention may be applied also to electrochemical batteries which use other ingredients and electrodes for such batteries, in addition to lithium-ion batteries.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. An electrode for battery, comprising:
a base member which serves as a current collector; and
an active material layer of an active material which is formed by a plurality of active material lines extending on a surface of the base member along a predetermined longitudinal direction,
wherein the active material lines include first lines whose width in orthogonal cross section to the longitudinal direction is a first width and second lines whose width in orthogonal cross section to the longitudinal direction is a second width which is wider than the first width and whose height measured from the surface of the base member is equal to or higher than a height of the first lines.

2. The electrode for battery according to claim 1, wherein at least one piece of the first lines is disposed between two pieces of the second lines.

3. The electrode for battery according to claim 1, wherein the ratio of the height to the width of the second lines in the orthogonal cross section is smaller than 1.

4. The electrode for battery according to claim 1, wherein the ratio of the height to the width of the first lines in the orthogonal cross section is equal to or greater than 1.

5. The electrode for battery according to claim 1, wherein a line gap of a line pair consisting of two adjacent active material lines remains same in any line pairs.

6. The electrode for battery according to claim 1, wherein the active material lines are arranged such that outermost active material lines among the active material lines arranged on the base member are the second lines.

7. A battery, comprising:
a positive electrode including a positive electrode current collector and a positive active material layer;
a negative electrode including a negative electrode current collector and a negative active material layer; and
an electrolyte layer which is disposed between the positive electrode and the negative electrode,
wherein at least one of the positive electrode and the negative electrode has same structure of the electrode for battery according to claim 1.

8. A method of manufacturing an electrode for battery, comprising the steps of:
applying an application liquid containing an active material to a surface of a base member, which serves as a current collector, in a form of lines and accordingly forming first lines made of the active material which extend in a predetermined longitudinal direction and whose width in orthogonal cross section to the longitudinal direction is a first width; and
applying the application liquid to the surface of the base member at different positions from positions of the first lines in a form of lines and accordingly forming second lines made of the active material which extend in the longitudinal direction and whose width in orthogonal cross section to the longitudinal direction is a second width which is wider than the first width and whose height measured from the surface of the base member is equal to or higher than the height of the first lines.

9. The manufacturing method of the electrode for battery according to claim 8,
wherein the application liquid is applied to the surface of the base member while the base member and an application liquid ejector, in which a plurality of outlets for continuously ejecting the application liquid are provided, are moved relative to each other in the longitudinal direction, the plurality of outlets include first outlets whose aperture width corresponds to the first width and second outlets whose aperture width corresponds to the second width, and the application liquid is ejected simultaneously from the first outlets and the second outlets.

10. The manufacturing method of the electrode for battery according to claim 9, further comprising a step of:
applying the application liquid to the surface of the base member while a sheet-like base member is transported in the longitudinal direction and winding the base member to which the application liquid is applied.

11. The manufacturing method of the electrode for battery according to claim 8, further comprising a step of:
pressing the first lines and the second lines formed on the surface of the base member with predetermined pressing force.

12. An apparatus for manufacturing an electrode for battery, comprising:
an application liquid ejector which includes a plurality of outlets which are arranged in a line in a predetermined arrangement direction and ejecting an application liquid containing an active material from each one of the outlets; and
a relative mover which moves the base member and the application liquid ejector relative to each other in a direction which intersects the arrangement direction in a condition that a surface of the base member which functions as a current collector is opposed to each one of the plurality of outlets,
wherein the plurality of outlets include a plurality of first outlets which have same aperture width in the arrangement direction and a plurality of second outlets which have same aperture width in the arrangement direction and whose aperture width is wider than an aperture width of first outlets, the active material contained in the application liquid ejected from the first outlets forms, on the surface of the base member, first lines which have a first width, and the active material contained in the application liquid ejected from the second outlets forms, on the surface of the base member, second lines which have a second width which is wider than the first width and whose height measured from the surface of the base member is equal to or higher than a height of the first lines.

13. The apparatus for manufacturing the electrode for battery according to the claim 12, further comprising: a winder which winds up a sheet-like base member after application of the application liquid.
